(19) United States
(12) Patent Application Publication
(10) Pub. No.: US 2015/0153002 A1
(43) Pub. Date: Jun. 4, 2015

(54) MANUFACTURING METHOD OF TANK AND MANUFACTURING APPARATUS OF TANK

(71) Applicant: Toyota Jidosha Kabushiki Kaisha, Toyota-shi (JP)

(72) Inventor: Akira Tanabe, Okazaki-shi (JP)

(21) Appl. No.: 14/551,473

(22) Filed: Nov. 24, 2014

(30) Foreign Application Priority Data
Dec. 4, 2013 (JP) 2013-250910

(51) Int. Cl. F17C 1/06; B32B 41/00; B32B 37/14

(52) U.S. Cl. CPC F17C 1/06; B32B 37/142; B32B 41/00; F17C 2203/0626; F17C 2203/0609; B32B 2439/00

(57) ABSTRACT

A manufacturing method of a tank having fiber wound on outer periphery of a liner comprises the steps of: (a) heating a fiber; (b) winding the heated fiber on the outer periphery of the liner; (c) obtaining temperature of the fiber wound on the outer periphery of the liner; and (d) detecting position of the fiber wound on the outer periphery of the liner relative to the liner, based on the obtained temperature of the fiber wound on the outer periphery of the liner.

### CROSS-REFERENCE TO RELATED APPLICATIONS

The present application claims the priority based on Japanese Patent Application No. 2013-250910 filed on Dec. 4, 2013, the disclosure of which is hereby incorporated by reference in its entirety.

### BACKGROUND

1. Field

The present invention relates to a manufacturing method of a tank and a manufacturing apparatus of a tank.

2. Related Art

In manufacturing a high-pressure tank (hereinafter called “tank”), fiber is wound on a liner of the tank, in order to enhance the pressure resistance. For example, a technique described in JP 2010-253789A takes images of a liner and fiber previously wound on the liner and identifies a color difference to detect the position of fiber wound on the liner.

In an application of winding fiber in multiple layers where fiber is wound on previously wound fiber, however, when the fibers of the respective layers have an identical color, this technique has difficulty in detecting the position of the fiber with high accuracy based on the color difference. There is accordingly a need for a technique that detects the position of fiber wound on the liner with high accuracy.

### SUMMARY

According to one aspect of the invention, there is provided a manufacturing method of a tank having fiber wound on outer periphery of a liner. This manufacturing method comprises the steps of: (a) heating a fiber; (b) winding the heated fiber on the outer periphery of the liner; (c) obtaining temperature of the fiber wound on the outer periphery of the liner; and (d) detecting position of the fiber wound on the outer periphery of the liner relative to the liner, based on the obtained temperature of the fiber wound on the outer periphery of the liner.

### BRIEF DESCRIPTION OF THE DRAWINGS

FIG. 1 is a diagram illustrating the configuration of a tank manufacturing apparatus;

FIG. 2 is a flowchart showing a manufacturing method of a tank performed by the tank manufacturing apparatus;

FIG. 3 is a diagram illustrating a liner;

FIG. 4(A) is a diagram illustrating the state that fiber is wound on the outer periphery of the liner;

FIG. 4(B) is an enlarged view of a broken line part C in FIG. 4(A); and

FIG. 5 is a chart showing relationship between observed temperature and distance from an end of a mouthpiece when the fiber is wound up to an (n+1)-th layer.

### DESCRIPTION OF EMBODIMENTS

### A. Embodiment

### A1. Configuration of Tank Manufacturing Apparatus

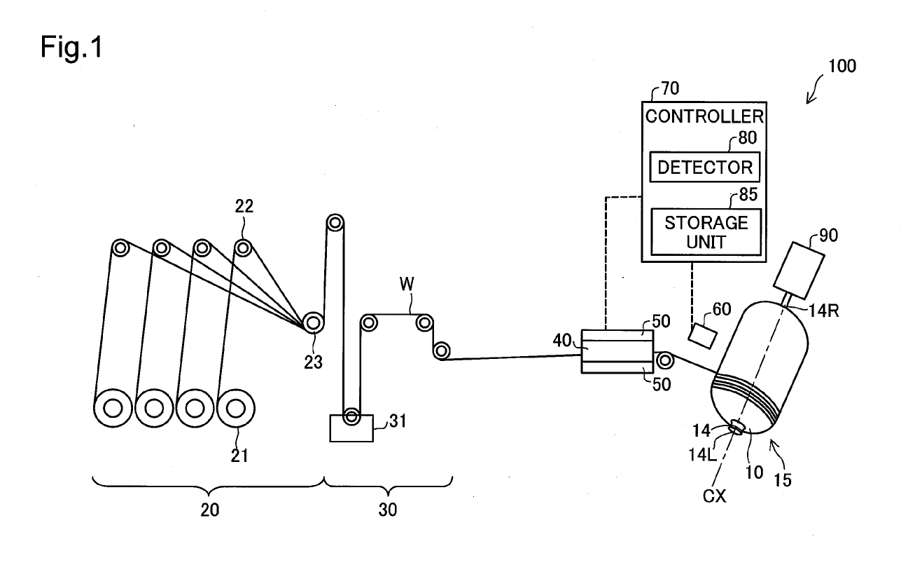

FIG. 1 is a diagram illustrating the configuration of a tank manufacturing apparatus 100. The tank manufacturing apparatus 100 is provided as an apparatus for manufacturing a tank 15 having fiber W wound on a liner 10. The tank manufacturing apparatus 100 includes a fiber wind-off unit 20, a resin impregnating unit 30, a fitting unit 40, a heating unit 50, infrared cameras 60, a controller 70 and a liner rotation device 90.

The fiber wind-off unit 20 is provided as a device configured to wind off fibers. The fiber wind-off unit 20 includes a plurality of bobbins 21, a plurality of conveyor rollers 22 and a binding roller 23. Carbon fibers are wound on the respective bobbins 21 according to this embodiment. The binding roller 23 adjusts a plurality of fibers wound off the respective bobbins 21 and winds off the adjusted fibers to the resin impregnating unit 30.

The resin impregnating unit 30 has a tank 31 containing a thermosetting epoxy rein in the liquid form and causes the fibers wound off the fiber wind-off unit 20 to be impregnated with the epoxy resin.

The fitting unit 40 is a mechanism configured to adjust fiber W impregnated with the epoxy resin to a bundle and guide the fiber W to the liner 10 to be wound on the liner 10. The fitting unit 40 corresponds to a “winder”.

The heating unit 50 heats the fiber W. According to this embodiment, the heating unit 50 is integrated with the fitting unit 40 and is configured to heat the fiber W guided by the fitting unit 40 using a high-frequency coil. The heating temperature may be, for example, environment temperature where the tank manufacturing apparatus 100 is placed +10° C. or higher and can be selected in the temperature range of not higher than 100° C. In this temperature range, the epoxy resin impregnated in the fiber W is not cured.

The liner rotation device 90 is configured to rotate the liner 10, so as to apply a tensile force to the fiber W and wind the heated fiber W on the liner 10.

The infrared cameras 60 are configured to obtain the temperature of the liner 10 located in a shooting range and the temperatures of the fiber W wound on the liner 10. The infrared cameras 60 correspond to an “acquirer”.

The controller 70 includes a detector 80 and a storage unit 85. The detector 80 detects the position of the fiber wound on the outer periphery of the liner 10 relative to the liner 10, based on the temperatures obtained by the infrared cameras 60. According to this embodiment, the detector 80 detects the positions of the fiber W on an outer most layer wound on the liner 10 relative to the positions of ends 14L and 14R of the liner 10. The storage unit 85 stores predetermined positions of the fiber W relative to the liner 10.

The controller 70 controls, for example, the fiber wind-off unit 20, the resin impregnating unit 30, the fitting unit 40, the heating unit 50, the infrared cameras 60 and the liner rotation device 90 described above, so as to wind the fiber W on the outer periphery of the liner 10. The controller 70 compares the detected position of the fiber W with the predetermined position of the fiber W relative to the liner 10 stored in the storage unit 85 and determines whether the position of the fiber W wound on the outer periphery of the liner 10 is right or wrong. When it is determined that the position of the fiber W is different from the predetermined position (upon determination of wrong position), the controller 70 controls, for example, the fiber wind-off unit 20, the fitting unit 40 and the liner rotation device 90 to stop winding of the fiber Won the outer periphery of the liner 10.

### A2. Manufacturing Method of Tank

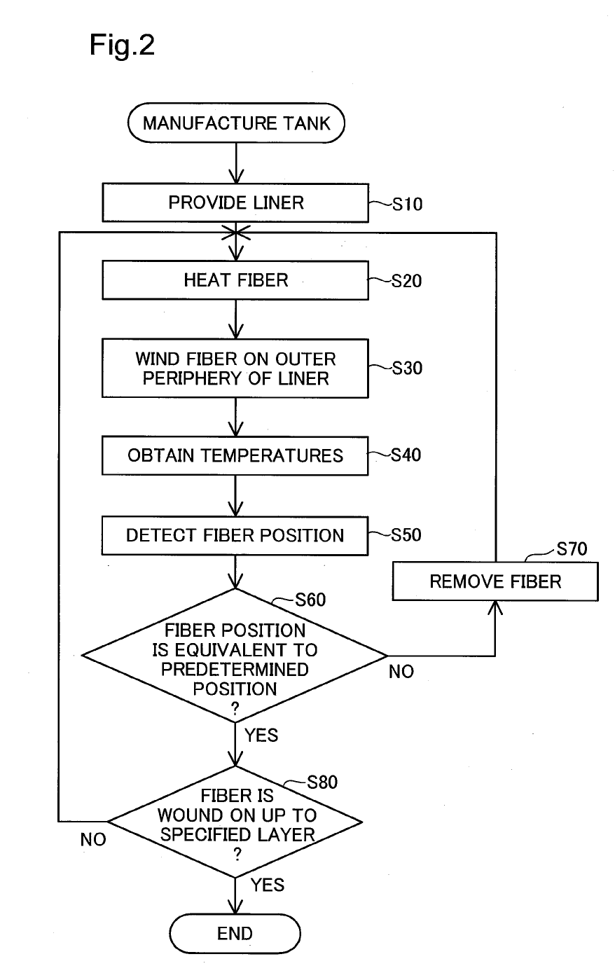

FIG. 2 is a flowchart showing a manufacturing method of a tank performed by the tank manufacturing apparatus 100. The procedure of manufacturing the tank 15 first provides the liner 10 (step S10).

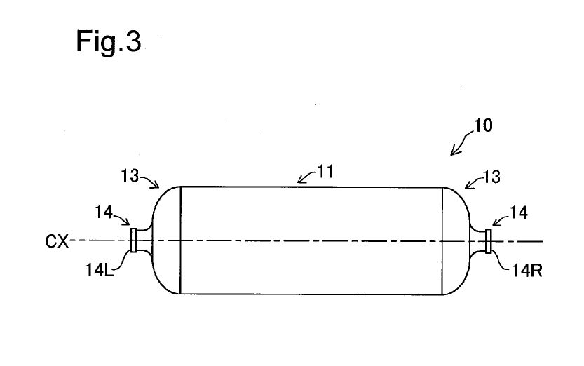

FIG. 3 is a diagram illustrating the liner 10. The liner 10 is provided as a hollow container including a cylinder section 11 in an approximately cylindrical shape and dome sections 13 in an approximately hemispherical shape provided on both ends of the cylinder section 11. The liner 10 may be made of a resin material such as a nylon-based resin. The respective tops of the two dome sections 13 are located on a center axis CX of the liner 10. Mouthpieces 14 for attachment of a pipe or a valve are provided on the tops of the respective dome sections 13.

After the liner 10 is provided, the heating unit 50 is operated to heat the fiber W (step S20 in FIG. 2). The heating unit 50 heats the fiber W to a specific temperature that is lower than the curing temperature of the epoxy resin impregnated into the fiber W but is higher than the environment temperature where the liner 10 is placed. For example, the heating unit 50 heats the fiber W with setting the upper limit temperature to 100° C. and the lower limit temperature to environment temperature +10° C. According to this embodiment, the environment temperature is about 20 to 30° C., and the heating unit 50 heats the fiber W to about 70 to 80° C.

The fitting unit 40 is subsequently operated to guide the heated fiber W to be wound on the outer periphery of the liner 10 (step S30 in FIG. 2).

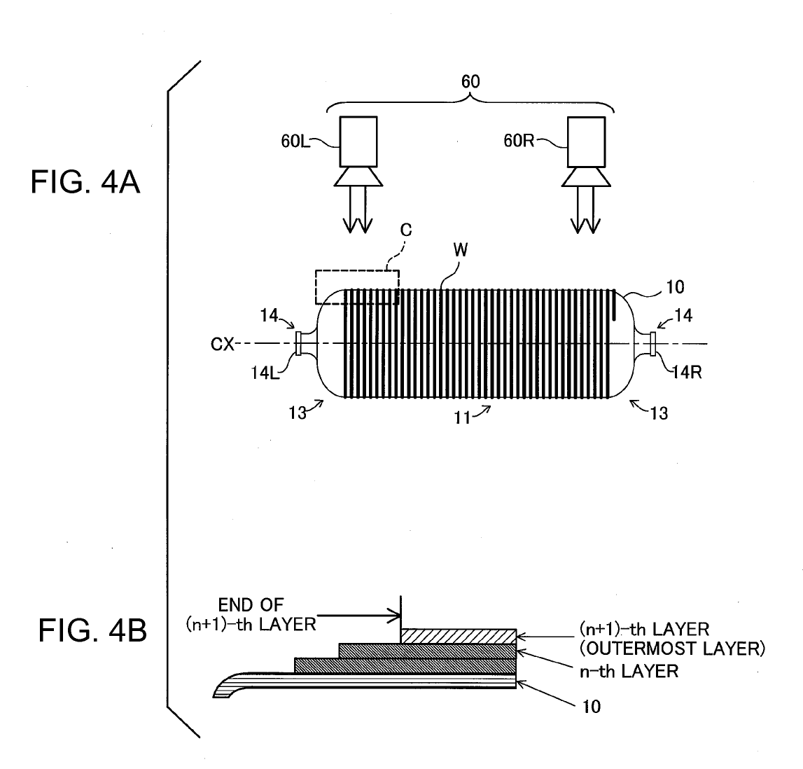

FIG. 4(A) is a diagram illustrating the state that the fiber W is wound on the outer periphery of the liner 10. The infrared cameras 60 placed in the neighborhood of the liner 10 are also shown in FIG. 4(A). According to this embodiment, the infrared cameras 60 include two infrared cameras 60R and 60L. The infrared camera 60L is placed to shoot from an end 14L of one of the mouthpieces 14 to the dome section 13 in the vicinity of the end 14L and the cylinder section 11. The infrared camera 60R is, on the other hand, placed to shoot from an end 14R of the other of the mouthpieces 14 to the dome section 13 in the vicinity of the end 14R and the cylinder section 11. In FIG. 4(A), the fiber W is wound on the liner 10 at approximately right angle to a direction parallel to the center axis CX of the liner 10. Such winding of the fiber W is called “hoop (FRP) winding”, and the width of hoop winding in the direction parallel to the center axis CX is called “hoop (FRP) width”. The tank manufacturing apparatus 100 is not limited to the hoop winding but is also capable of winding the fiber W on the outer periphery of the liner 10 by “helical winding” which winds the fiber W on the outer periphery of the liner 10 at a specified angle other than approximately right angle. For simplicity of explanation, the embodiment describes an aspect of the tank manufacturing apparatus 100 that winds the fiber W on the liner 10 by hoop winding.

FIG. 4(B) is an enlarged view of a broken line part C in FIG. 4(A). FIG. 4(B) shows the state that the fiber W is wound up to an (n+1)-th layer on the outer periphery of the liner 10 on the end 14L-side of one of the mouthpieces 14.

The infrared cameras 60 are then operated to obtain the temperatures of the fiber W wound on the outer periphery of the liner 10 (step S40 in FIG. 2). At step S40, the infrared cameras 60 take images in the peripheries of the cylinder section 11 and the dome sections 13 of the liner 10, so as to obtain the temperatures of the fiber W and the temperature of the liner 10 in the shooting range.

After the temperatures are obtained by the infrared cameras 60, the detector 80 is operated to detect the position of the wound fiber W relative to the liner 10, based on the obtained temperatures (step S50 in FIG. 2).

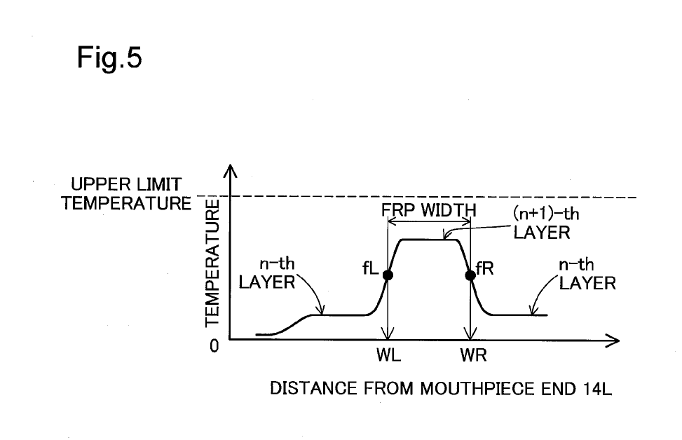

FIG. 5 is a chart showing relationship between the observed temperature and the distance from the end 14L of the mouthpiece 14 when the fiber W is wound up to an (n+1)-th layer. FIG. 5 shows a graph with the temperature as ordinate and the distance from the end 14L of the mouthpiece 14 as abscissa. In this state, the fiber W has been wound up to an n-th layer on the outer periphery of the liner 10, and the fiber W of an (n+1)-th layer is being wound on the fiber W of the n-th layer. The previously wound fiber up to the n-th layer has been heated prior to winding but has the temperature decreasing by release of heat to the fiber of the lower layers and the liner 10. Accordingly, among the temperatures obtained by the infrared cameras 60, the fiber of the (n+1)-th layer has the highest temperature, the fiber of the n-th layer has the second highest temperature, and the liner 10 has the lowest temperature. For example, the fiber W of the n-th layer and the fiber W of the (n+1)-th layer have a temperature difference of about 20 to 30° C. The temperature at the end of the fiber W on the (n+1)-th layer is decreased by heat release to become closer to the temperature of the fiber W of the n-th layer. The relationship between the observed temperature and the distance from the mouthpiece 14 (position) accordingly provides a curve graph as shown in FIG. 5.

The detector 80 computes an inflection point fL of the curve graph and specifies a position corresponding to the inflection point fL as a position WL of an end of the fiber Won the end 14L-side of one of the mouthpieces 14. Similarly the detector 80 computes an inflection point fR of the curve graph and specifies a position corresponding to the inflection point fR as a position WR of an end of the fiber W on the end 14R side of the other of the mouthpieces 14. The detector 80 also calculates a distance from the position WL of the end of the fiber W to the position WR of the end of the fiber W as hoop width (FRP width).

After detection of the position WL of the fiber W on the outermost layer, the controller 70 determines whether the position of the fiber W wound on the liner 10 is equivalent to a predetermined position (S60 in FIG. 2). The positions of the fiber W on each layer from the respective ends 14L and 14R of the mouthpieces 14 have been determined in advance and stored in the storage unit 85. More specifically, the controller 70 determines whether the position WL of the fiber W from the end 14L of the mouthpiece 14 is in a range of tolerance of the predetermined position.

When the position WL of the fiber W on the (n+1)-th layer from the end 14L of the mouthpiece 14 is equivalent to the predetermined position, i.e., upon determination of right position of the fiber W (step S60: YES in FIG. 2), the controller 70 subsequently determines whether the fiber W has been wound up to a specified layer on the outer periphery of the liner 10 (step S80). When the fiber W has not yet been wound up to the specified layer on the outer periphery of the liner 10 (step S80: NO), the controller 70 controls the respective components of the tank manufacturing apparatus 100 and successively repeats the processing of steps S20 to S60. For example, the determination of whether the fiber W has been wound up to the specified layer on the liner 10 may be based on detection of the specified layer on both the end 14L-side and the end 14R-side when the fiber is wound from the end 14L-side of one of the mouthpieces 14 toward the end 14R-side of the other of the mouthpieces 14.

When the position WL of the fiber W on the (n+1)-th layer is different from the predetermined position, i.e., upon determination of wrong position of the fiber W (step S60: NO in FIG. 2), on the other hand, the fiber of the layer under determination of wrong position (i.e., (n+1)-th layer in this example) is removed from the liner 10 (step S70). More specifically, the controller 70 controls, for example, the fiber wind-off unit 20, the fitting unit 40 and the liner rotation device 90 to stop winding of the fiber W on the outer periphery of the liner 10. After winding of the fiber W is stopped, for example, the operator may remove the fiber W of the (n+1)-th layer from the liner 10.

After removal of the fiber W of the (n+1)-th layer from the liner 10, the controller 70 controls, for example, the position of the fitting unit 40 relative to the liner 10 and the rotation of the liner rotation device 90 and repeats the processing of steps S20 to S60, so as to cause the position WL of the fiber W on the (n+1)-th layer to be equivalent to the predetermined position. This series of operations modifies the position of the fiber W wound on the liner 10.

When the position WL of the fiber W wound on the liner 10 is equivalent to the predetermined position (upon determination of right position) (step S60: YES) and when the fiber W has been wound up to the specified layer on the liner 10 (step S80: YES), the procedure of manufacturing the tank 15 by the tank manufacturing apparatus 100 is completed. The manufactured tank 15 is subsequently subjected to a thermal curing process which cures the resin impregnated into the fiber and a part assembling process and is filled with, for example, hydrogen gas.

### A3. Advantageous Effects

The manufacturing method of the tank 15 described above detects the position of the fiber W wound on the outer periphery of the liner 10, based on the temperatures of the fiber W. This method enables the position of the fiber W wound on the outer periphery of the liner 10 to be detected with high accuracy. In the application that the fiber W is wound in multiple layers, the position of the newly wound fiber W is detectable, based on the temperature difference between the fiber W previously wound on the outer periphery of the liner 10 and the newly wound fiber W. This method accordingly ensures detection of the position of the fiber with higher accuracy, compared with the method of detecting the position of the fiber W based on the color of the fiber.

This method can determine whether the position of the fiber W wound on the outer periphery of the liner 10 is right position or wrong position, while winding the fiber W on the outer periphery of the liner 10. This method does not need to stop the process of winding the fiber W on the outer periphery of the liner 10 on the occasion of determining the right position or the wrong position of the fiber W. This accordingly shortens the total time required for manufacturing the tank 15. Additionally, upon determination that the position of the fiber W is different from the predetermined position, this method stops the operation of the tank manufacturing apparatus 100 and modifies the position of the fiber W wound on the outer periphery of the liner 10. This enables the fiber W to be wound at the adequate position on the liner 10.

The right position or wrong position of the fiber W is readily determinable, based on the temperatures obtained by the infrared cameras 60. This method can thus immediately stop the operation of the tank manufacturing apparatus 100 and stop further winding of the fiber W on the liner 10, upon determination that the position of the fiber W is different from the predetermined position. This accordingly decreases the quantity of the fiber W to be removed from the liner 10 when the position of the fiber W is modified, thus reducing the workload of the operation required for manufacturing the tank 15 and the cost of manufacturing.

### B. Modifications

### B1. Modification 1

The above embodiment describes the manufacturing method of the tank with detection of the position of the fiber in the application of hoop winding of the fiber W on the liner 10. In the application of helical winding of the fiber W on the liner 10, the detector 80 may similarly detect the position WL of the fiber W on the end 14L-side of one of the mouthpieces 14, based on the temperatures obtained by the infrared cameras 60. The detector 80 may also detect the angle of helical winding by computing an angle between a straight line of connecting two different positions of the fiber W and the center axis CX. The controller 70 may subsequently determine whether the detected angle of helical winding is equivalent to a predetermined angle. Upon determination that the angle of helical winding is different from the predetermined angle, the controller 70 may control the tank manufacturing apparatus 100 to modify the angle of helical winding.

### B2. Modification 2

In the above embodiment, the tank manufacturing apparatus 100 includes the resin impregnating unit 30 which impregnates the fiber wound off by the fiber wind-off unit 20 with the epoxy resin. Alternatively the fiber wind-off unit 20 may wind off a sheet member of the fiber W impregnated with a resin in advance (prepreg). In the application using prepreg, the resin impregnating unit 30 may be omitted from the tank manufacturing apparatus 100.

### B3. Modification 3

In the above embodiment, the heating unit 50 is integrated with the fitting unit 40. Alternatively the heating unit 50 may be provided separately from the fitting unit 40. For example, the heating unit 50 may be provided between the fitting unit 40 and the liner 10.

### B4. Modification 4

In the above embodiment, the two infrared cameras 60L and 60R are used to respectively obtain the temperatures on the end 14L-side and on the end 14R-side of the respective mouthpieces 14. Alternatively only one infrared camera may be used to obtain both the temperatures on the end 14L-side and on the end 14R-side of the respective mouthpieces 14. Only one infrared camera may be moved in the direction parallel to the center axis CX of the tank 15, in order to take images both on the end 14L-side and on the end 14R-side of the respective mouthpieces 14.

### B5. Modification 5

In the above embodiment, the fiber W of the (n+1)-th layer and the fiber W of the n-th layer wound on the liner 10 have the temperature difference of about 20 to 30° C. The temperature of the fiber W heated by the heating unit 50 may be set to such a temperature that provides a temperature difference of, for example, about 5° C. or about 1 to 2° C. between the fiber W of the (n+1)-th layer and the fiber W of the n-th layer wound on the liner 10. Even such a temperature difference allows for discrimination between the temperature of the (n+1)-th layer and the temperature of the n-th layer by means of the infrared cameras 60. The detector 80 can thus detect the position of the fiber W on the (n+1)-th layer.

According to one aspect of the invention, there is provided a manufacturing method of a tank having fiber wound on outer periphery of a liner. This manufacturing method comprises the steps of: (a) heating a fiber; (b) winding the heated fiber on the outer periphery of the liner; (c) obtaining temperature of the fiber wound on the outer periphery of the liner; and (d) detecting position of the fiber wound on the outer periphery of the liner relative to the liner, based on the obtained temperature of the fiber wound on the outer periphery of the liner. The manufacturing method of the tank according to this aspect detects the position of the fiber wound on the outer periphery of the liner, based on the temperature of the fiber. This enables the position of the fiber wound on the outer periphery of the liner to be detected with high accuracy. In the application that the fiber is wound in multiple layers, the position of newly wound fiber relative to the liner is detectable with high accuracy, based on a temperature difference between fiber previously wound on the outer periphery of the liner and the newly wound fiber.

In the manufacturing method of the tank of the above aspect, the step (d) may further determine whether the detected position of the fiber wound on the outer periphery of the liner relative to the liner is right position or wrong position. The manufacturing method of the tank of this configuration can determine whether the position of the fiber is right position or wrong position with high accuracy.

In the manufacturing method of the tank of the above aspect, upon determination that the detected position of the fiber is different from a predetermined position, the step (d) may modify the position of the fiber wound on the outer periphery of the liner relative to the liner. The manufacturing method of the tank of this configuration enables the fiber to be wound at the adequate position relative to the liner.

In the manufacturing method of the tank of the above aspect, the step (d) may detect position of the fiber on an outermost layer out of the fiber wound on the outer periphery of the liner, relative to the liner, based on the obtained temperature of the fiber wound on the outer periphery of the liner. The manufacturing method of the tank of this configuration can detect the position of the fiber on the outermost layer with high accuracy, based on a temperature difference between the fiber of the outermost layer out of the fiber previously wound on the outer periphery of the liner and the fiber of another layer or the liner.

The invention may be implemented by any of various aspects other than the manufacturing method of the tank described above; for example, an apparatus for detecting position of fiber wound on outer periphery of a liner, and a manufacturing apparatus of a tank.

The invention is not limited to any of the embodiments, the examples and the modifications described above but may be implemented by a diversity of other configurations without departing from the scope of the invention. For example, the technical features of the embodiments, examples or modifications corresponding to the technical features of the respective aspects may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A manufacturing method of a tank having fiber wound on outer periphery of a liner, the manufacturing method of the tank comprising the steps of:
(a) heating a fiber;
(b) winding the heated fiber on the outer periphery of the liner;
(c) obtaining temperature of the fiber wound on the outer periphery of the liner; and
(d) detecting position of the fiber wound on the outer periphery of the liner relative to the liner, based on the obtained temperature of the fiber wound on the outer periphery of the liner.

2. The manufacturing method of the tank according to claim 1, wherein the step (d) further determines whether the detected position of the fiber wound on the outer periphery of the liner relative to the liner is right position or wrong position.

3. The manufacturing method of the tank according to claim 2, wherein upon determination that the detected position of the fiber is different from a predetermined position, the step (d) modifies the position of the fiber wound on the outer periphery of the liner relative to the liner.

4. The manufacturing method of the tank according to claim 1, wherein the step (d) detects position of the fiber on an outermost layer out of the fiber wound on the outer periphery of the liner, relative to the liner, based on the obtained temperature of the fiber wound on the outer periphery of the liner.

5. A manufacturing apparatus of a tank having fiber wound on outer periphery of a liner, the manufacturing apparatus of the tank comprising:
a heater configured to heat a fiber;
a winder configured to wind the heated fiber on the outer periphery of the liner;
an acquirer configured to obtain temperature of the fiber wound on the outer periphery of the liner; and
a detector configured to detect position of the fiber wound on the outer periphery of the liner relative to the liner, based on the obtained temperature of the fiber wound on the outer periphery of the liner.
